(19) United States
(12) Patent Application Publication
(10) Pub. No.: US 2005/0246528 A1
(43) Pub. Date: Nov. 3, 2005

(54) Method for reliable authentication of electronic transactions

(76) Inventor: John Stephenson Powers, Fairfax, VA (US)

Correspondence Address: IMAGTEK CORPORATION, 4415 SAN CARLOS DRIVE, FAIRFAX, VA, 22030, US

(21) Appl. No.: 10/834,954

(22) Filed: Apr. 30, 2004

(51) Int. Cl. H04L 9/00

(52) U.S. Cl. 713/168

(57) ABSTRACT

A method for reliable authentication of electronic transactions, whereby each authentication is unique, immune to cryptanalysis attacks, and information from intercepted transactions cannot be used to authenticate or facilitate authentication of future transactions.

### CROSS REFERENCE TO RELATED APPLICATIONS

None

### STATEMENT REGARDING FEDERALLY SPONSORED RESEARCH AND DEVELOPMENT

This invention was developed without assistance from any government agency.

### BACKGROUND OF THE INVENTION

1. Field of the Invention

This invention pertains to the field of authenticating electronic transactions in order to deny fraudulent transactions attempted by unauthorized entities. More specifically, this invention enables any server of an electronic transaction request by a client to instantly verify, with extremely high confidence, the authorization of said client to conduct the transaction.

2. Description of Related Art

Electronic transactions are generally authenticated via an identification code or password that is presumed to be held in secret between parties conducting the transaction. Prime examples are credit card accounts based upon numeric codes, and password protected computer accounts. Variants of this approach may add additional items such as personal information to the requirement for an identification code or password, or solicit more secret information in the form of a challenge issued by the server, but the basic approach is the same. This password/secret information approach is vulnerable to numerous attacks resulting in interception of authentication codes by unauthorized entities. Because of this, credit card fraud runs into billions of dollars per year in the US alone, while password protected computer systems are routinely compromised by outsiders.

The present state of the art in electronic authentication suffers the fundamental flaw that interception of a transaction by a third party will provide that party with sufficient information to conduct successful, fraudulent transactions. Even encrypted transactions are vulnerable to cryptanalysis attacks that may reveal sufficient account information to launch successful fraudulent transactions.

### SUMMARY OF THE INVENTION

This invention creates a new and robust method for authentication of electronic transactions that is immune to compromise via interception or cryptanalysis. In this method, a client initiating a transaction with a server sends a numeric or other identifier of the client account on the server, and provides with the account identifier a unique, random and non-reusable authentication code proving that the transaction originates from the client as claimed, and not from fraudulent use of intercepted client information. This method is an advance of the state of the art since every transaction authentication is unique, random and non-reusable. Although the method of authentication is unencrypted, it is analogous to the ‘one time pad’ method of encryption, since an intercepted transaction cannot be reused to authenticate future transactions, nor to determine the method of authentication sufficiently to reproduce it. Similarly, the uniqueness of every transaction, even unsuccessful transaction attempts, foils trial-and-error cryptanalysis attacks.

This invention introduces a methodology for reliably authenticating electronic transactions to an extremely high level of confidence, while requiring minimal computation resources and (in the simple case) only one-way communication between participants to the transaction. Its low computational overhead makes it an attractive candidate for applications involving massive volumes of transactions that must be rapidly and reliably authenticated.

### BRIEF DESCRIPTION OF THE DRAWINGS

FIG. 1 is a block diagram depicting the transaction flow among participating parties in the transaction authentication process described herein.

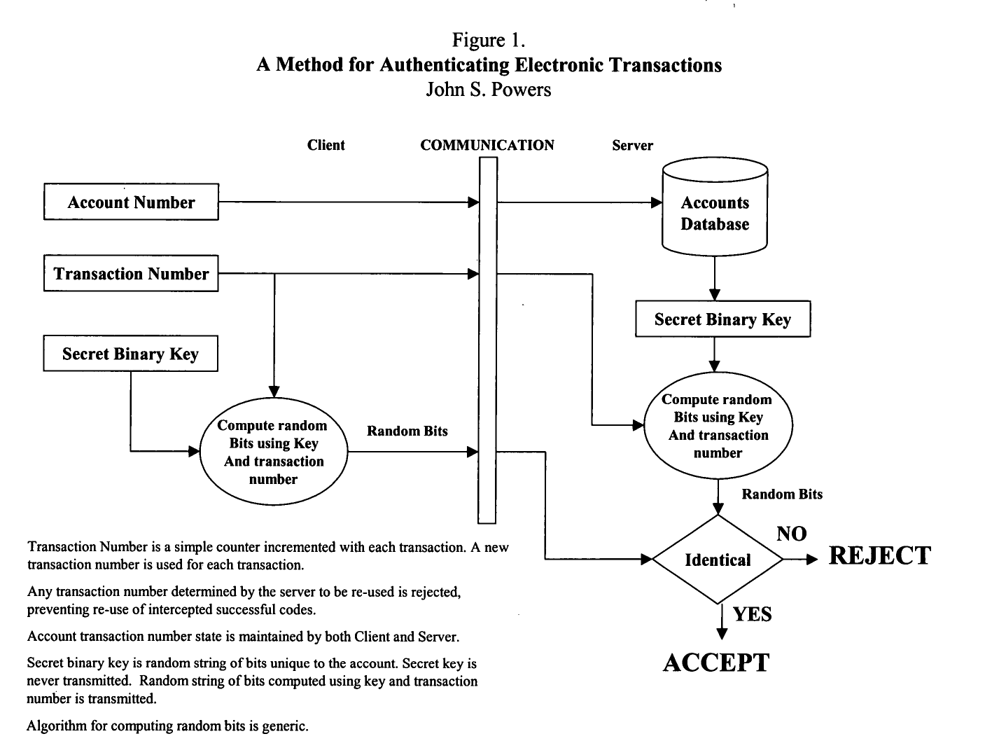

### DETAILED DESCRIPTION OF THE INVENTION

All electronic transactions are presumed to consist of a transaction initiator (client) and a recipient (server) that consummates the desired transaction on an account. A transaction server may receive and process transaction requests from an unlimited number of clients. The client and server may switch roles between transactions on the same account, depending upon which entity initiates the transaction (client) and which entity fulfills the request (server).

The invention consists of five logical components:
1. an account identifier, consisting a unique numeric code, character string or other information that uniquely designates a client account.
2. an account secret key, consisting of a random bit string that is unique to the client account and is maintained in the client account, and does not change.
3. an account transaction number, that may be a simple counter or other means of uniquely identifying individual transactions, and is maintained in the client account. The account transaction number is updated on the server with every transaction attempt on the account.
4. a memory, that maintains the account identifier, the account secret key, and the account transaction number, as well as other information relating to the account.
5. an algorithm and implementation, either in software or hardware, that takes the states of the account transaction number and account secret key as input, and computes a unique, random bit string as output. The random bit string output by the computation serves as the authentication code for a single transaction on the account identified by the account transaction number.

The basic protocol for a typical transaction is as follows:

A client initiates a transaction with an account server via a communication protocol. The client provides the account identifier, an account transaction number, and a random bit string computed by use of an algorithm implementation using the account transaction number and secret key. The transaction number is unique and may never used again on that account, unless the account is reset by the server.

As a variant on transaction initiation, the client may request the server to communicate the next available transaction number on the account. This identifier is then used by the client to compute the random bit string before initiating the transaction. The providing of the next transaction number by the server on demand does not compromise the integrity of the authentication process, since the transaction number provided may be used only by the requesting client.

Upon receipt of the transaction request from the client, the account server uses the client account identifier to determine if the transaction number sent with the request is available on the account. If the number has been used previously, the transaction is denied. If the transaction number is available, the server uses the secret key associated with the account on the server, and the transaction number sent with the client request, to compute a random bit string using an algorithm implementation identical to that used by the client.

The random bit string received from the client with the transaction request, and the random bit string computed on the server, are compared. If the random bit strings of the client and server match exactly, then authentication succeeds, the transaction is consummated. If the strings do not match, the transaction is denied. In either case, the account transaction number is incremented or otherwise flagged as used on the server

Of crucial relevance to the above invention is the fact that every transaction authentication is unique and non-reusable. An intercepted transaction has no utility whatsoever in facilitating any future, fraudulent transaction. Repeated attempts to determine the secret code associated with a transaction number will fail because every transaction attempt is assigned a unique and non-reusable transaction number, and the random bit string computed from the transaction number on an account is unique and unpredictable for every transaction. Brute force cryptanalysis attacks against the account are impossible. Similarly, the secret key used to compute the random bit string is never transmitted and is therefore not accessible to interception by a third party. Determining the secret key from transaction results is rendered further resistant to cryptanalysis attacks, since the length of the random bit string relative to the length of the secret key is insufficient to deduce the secret key via any known cryptanalysis method.

1. A method for reliable authentication of electronic transactions, consisting of:
an account identifier;
a secret key, unique to the account;
a transaction number, unique to each transaction attempt on the account;
a memory, capable of storing the state of the account identifier, secret key, and transaction number.
an algorithm and implementation, in software or hardware, for computing a random bit string using the account secret key and transaction number as inputs.
a communication channel, by which a transaction request is communicated from the client to a server or, optionally, by which a server may provide the next available transaction number on an account to the client upon request.

2. The method of claim 1, whereby a random bit string is computed by a client via use of the account secret key, the transaction number, and the algorithm implementation, said random bit string, transaction number and account identifier being communicated to a server of the client account with the client request for a transaction on the account.

3. The method of claim 1, whereby authorization of a transaction on an account is denied by the account server if the account transaction number provided by the client is determined to have been previously used in an earlier transaction, or transaction attempt, on the account.

4. The method of claim 1, whereby a random bit string computed by the account server using the client provided transaction number and the secret key from the client account on the server, is compared with the random bit string presented by the client as proof of authorization to conduct a transaction on the account, the authorization being allowed if the strings match exactly, or denied if the strings do not match.

5. The method of claim 1, whereby the transaction number is updated on the server, and possibly the client as well, with each transaction request.

6. The method of claim 1, whereby the next available transaction number may be determined randomly or by a stochastic process.

7. The method of claim 1, whereby the role of client and server in the above invention may be interchanged between transactions.

8. The method of claim 1, whereby the authentication process occurs via a specialized hardware device, or via distributed computer software on generic computer equipment, either via direct manual input on said device/equipment, or via automatic process.

9. The method of claim 1, whereby the account information on the client or server may reside in encrypted form, and computation of authentication information may include an internal decryption step, so that no account information is ever visible or stored in unencrypted form.

10. The method of claim 1, whereby an encrypted checksum may be attached to the client request for a transaction number from the server, said checksum to be used by the server to detect en-route tampering with the ensuing client transaction request.

11. The method of claim 1, whereby the complete transaction between the client and server occurs in encrypted form.

12. The method of claim 1, whereby any ancillary information may be attached to a transaction.
